(19) United States
(12) Patent Application Publication
(10) Pub. No.: US 2017/0041329 A1
(43) Pub. Date: Feb. 9, 2017

(54) METHOD AND DEVICE FOR DETECTING AUTONOMOUS, SELF-PROPAGATING SOFTWARE

(71) Applicant: SIEMENS AKTIENGESELLSCHAFT

(72) Inventors: JAN GERRIT GÖBEL, MÜNCHEN (DE); HEIKO PATZLAFF, MÜNCHEN (DE); GERRIT ROTHMAIER, MÜNCHEN (DE)

(21) Appl. No.: 15/107,112

(22) PCT Filed: Jan. 16, 2015
(86) PCT No.: PCT/EP2015/050743

§ 371 Date: Jun. 22, 2016

(30) Foreign Application Priority Data
Jan. 29, 2014 (DE) 102014201592.8

(51) Int. Cl. H04L 29/06; H04L 29/08

(52) U.S. Cl. CPC H04L 63/145; H04L 67/12; H04L 63/1408; H04L 63/18

(57) ABSTRACT

A method and a device for detecting autonomous, self-propagating malicious software in at least one first computing unit in a first network, wherein the first network is coupled to a second network via a first link, having the following method steps: a) generating at least one first indicator which specifies a first behaviour of the at least one first computing unit; b) generating at least one second indicator which specifies a second behaviour of at least one second computing unit in the second network; c) transmitting the at least one first indicator and the at least one second indicator to a correlation component; d) generating at least one correlation result by correlating the at least one first indicator with the at least one second indicator; e) outputting an instruction signal if, when a comparison is made, a definable threshold value is exceeded by the correlation result, is provided.

### CROSS-REFERENCE TO RELATED APPLICATIONS

This application claims priority to PCT Application No. PCT/EP2015/050743, having a filing date of Jan. 16, 2015, based off of German application No. 102014201592.8, having a filing date of Jan. 29, 2014, the entire contents of which are hereby incorporated by reference.

### FIELD OF TECHNOLOGY

The following relates to methods and devices for detecting autonomous, self-propagating software.

### BACKGROUND

Attacks with malware programs which are transmitted in unauthorized manner to computer systems with the intention of causing harm to the confidentiality, integrity or availability of the data, applications or of the operating system on this computer system have become a serious threat in recent years. Known types of malware are viruses, worms, Trojan horses, rootkits and spyware. The distribution or infection with malware, respectively, can take place via E-mail, websites, file downloads and filesharing and peer-to-peer software, instant messaging and also by direct personal manipulation of computer systems.

To tackle these attacks, implementations are known. For example, a German utility model DE 10 2010 008 538 A1 having a title “Method and system for detecting malware” describes a solution for detecting malware in a computer storage system. A further German utility model DE 20 2013 102 179 U1 having the title “System for detecting malware performed by a machine” deals with a system for detecting malware, the code of which is executed by a virtual engine.

Furthermore, security-critical systems which are operated in special networks are not connected directly to the Internet today but can be reached initially only via a further network, e.g. an office network or network for configuring the special network.

In this context, protected special networks are computer networks which are isolated from other networks such as office networks and the Internet by suitable technical measures such as, e.g., firewall or air gap. Examples of systems considered are industrial control systems, e.g. in critical infrastructures, or systems for processing sensitive data.

An example of a special network is an automation network of a production line in which the production robots represent security-critical systems. Thus, the “decoupling” from the public network provides a protection of the special network from a malware attack starting from the public network. In addition, traditional detection mechanisms such as antivirus are also used on the security-critical systems in the special network.

However, it is found that the decoupling of the special network and monitoring of malware attacks in current operation of the special network do not offer an absolutely reliable protection from selective attacks since, for example, infected data from the further network can be transmitted by the user into the special network. Infected data can pass into the special network, and thus onto the security-critical systems, even with a physical isolation of the further network and of the special network, via mobile data carriers such as, e.g. USB sticks (USB Universal Serial Bus). Among others, this occurs with autonomous, self-propagating malware.

### SUMMARY

As aspect relates to improving a detection of attacks, especially by self-propagating malware, on a safe security-critical system in a special network.

Embodiments of the invention relate to a method for detecting autonomous, self-propagating malware in at least one first computer unit in a first network, wherein the first network is coupled to a second network via a first link, comprising the following method steps:
a) generating at least one first indicator which specifies a first behavior of the at least one first computer unit;
b) generating at least one second indicator which specifies a second behavior of at least one second computer unit in the second network;
c) conveying the at least one first indicator and the at least one second indicator to a correlation component;
d) generating at least one correlation result by correlating the at least one first indicator with the at least one second indicator,
e) outputting an instruction signal if, during a comparison, a definable threshold value is exceeded by the correlation result.

The method shows the advantage that the specific type of malware of “autonomous, self-propagating malware” can be detected by the fact that it occurs on two independent computer units which in each case belong to different networks. This case is of the highest significance particularly in the industrial environment since they are critical systems for malware attack in so-called special networks, such as, e.g., production lines, robotic systems, and money printing machines. These special networks can be physically isolated from other networks such as an office network with computers for data processing, or at least decoupled by electronic access controls in such a manner that a data exchange can only take place in special cases.

The method can be used universally for any type of autonomous, self-propagating malware so that a high rate of detection can be achieved also for unknown malware of the said type.

Within the framework of the present description, the term behavior is understood to be one or more activities which the respective first or second computer unit performs such as, for example, writing or reading of data or particular file names on or from a storage unit allocated to the respective computer unit, starting, pausing, stopping or ending of processes, e.g. with process names/or identifiers determined in each case. The behavior can describe a state of the respective computer unit or of the associated activities at a particular point in time and/or changes of the respective activities over a period of time.

A system for monitoring and/or controlling technical processes of industrial installations is advantageously formed by the first network and an office communication network is advantageously formed by the second network. It is especially in this context that the use of the method is particularly effective since the office network, due to its connection with other networks such as the Internet, for the exchange of information with external networks, is particularly susceptible to autonomous, self-propagating malware. In addition, the same persons use respective computer units in the first and second network so that a high hazard potential due to autonomous, self-propagating malware exists in the first network, that is to say in the special network, due to a data exchange.

In an optional embodiment of the invention, the respective behavior with respect to at least one of the following information items of the at least one first computer unit and the at least one second computer unit is determined by the at least one first indicator and the at least one second indicator:
at least one file name on a storage medium;
at least one name of a current or stopped process;
at least one result of an intrusion detection system;
characteristic of network traffic data within the first and second network.

The use of at least one of these information items is advantageous since the respective information can be determined without great technical expenditure and also provides proof for an existence of autonomous, self-propagating malware in a simple manner.

In a development, the at least one first indicator and the at least one second indicator are determined in dependence on a change of the respective information, particularly in dependence on a frequency of occurrence of the respective information. By this means, temporally cumulative anomalies such as cumulative occurrence of a particular behavior of the respective computer unit, or time sequences of particular information items can be fathomed advantageously in a reliable and simple manner.

In one embodiment of the invention, the at least one first indicator and the at least one second indicator are generated at regular intervals. This ensures that a continuous monitoring of the first and second computer units for autonomous, self-propagating malware is performed and thus a high reliability in the detection of this type of malware is provided. In particular, this ensures an earlier detection of the autonomous, self-propagating malware as a result of which any damage caused by the malware can be kept small. In addition, an “infestation” of other computer units can also be avoided or at least the distribution of the malware can be curbed.

In a further embodiment of the invention, a first type of behavior is indicated in a first time interval by the at least one first indicator and the first or further type of behavior is indicated in a second time interval by the at least one second indicator, the second time interval being arranged before the first time interval in time. By this means, behavior patterns of the autonomous, self-propagating malware can be detected advantageously, which improves a detection of the malware. For example, an activity of the malware is particularly high after an infestation of the respective computer unit and then decreases exponentially. Thus, the existence of this malware on the first and second computer unit can be verified very well not at the same time but at two different times.

In an optional embodiment of the invention, at least one of steps a), c), d), e) of the method is performed only after at least one data word of the at least one second computer unit has been transmitted to the at least one first computer unit. This advantageously has the result that up to method step b), further method steps only need to be performed when a data traffic, i.e. a data delivery from the second computer unit to the first computer unit, has occurred e.g. by means of USB stick. The data traffic is formed by the transmission of at least one data word, wherein the data word can comprise one or more bytes such as, e.g., all bytes of a file which is fed into the first computer unit.

Embodiments of the invention also relate to a device for detecting autonomous, self-propagating malware in at least one first computer unit in a first network, wherein the first network can be coupled to a second network via a first link, comprising the following units:
a) first unit for generating at least one first indicator which specifies a first behavior of the at least one first computer unit;
b) second unit for generating at least one second indicator which specifies a second behavior of at least one second computer unit of the second network;
c) third unit for conveying the at least one first indicator and the at least one second indicator to a correlation component;
d) fourth unit for generating at least one correlation result by correlating the at least one first indicator with the at least one second indicator:
e) fifth unit for outputting an instruction signal if, during a comparison, the definable threshold value is exceeded by the correlation result.

Advantageously, the first unit and the second unit are designed for generating the at least one first indicator and the at least one second indicator of the respective behavior with respect to at least one of the following information items:
at least one file name on a storage medium,
at least one name of a current or stopped process,
at least one result of an intrusion detection system,
characteristic of network traffic data within the first and second network.

In addition, the first unit and the second unit can perform the generating of the at least one first indicator and of the at least one second indicator in dependence on a change of the respective information, particularly in dependence on a frequency of occurrence of the respective information.

In an optional embodiment of the device, the first unit and the second unit perform the generating of the at least one first indicator and of the at least one second indicator at regular time intervals.

In an advantageous embodiment of the invention, a first type of behavior in a first time interval can be indicated by the at least one first indicator and the first or a further type of behavior in a second time interval can be indicated by a second indicator, the second time interval being arranged before the first time interval in time.

Advantages and explanations relating to the respective designs of the device according to embodiments of the invention are analogous to the corresponding method steps. In addition, other method steps presented can be implemented and executed by the device by means of a sixth unit.

### BRIEF DESCRIPTION

Some of the embodiments will be described in detail, with reference to the following figures, wherein like designations denote like members, wherein:

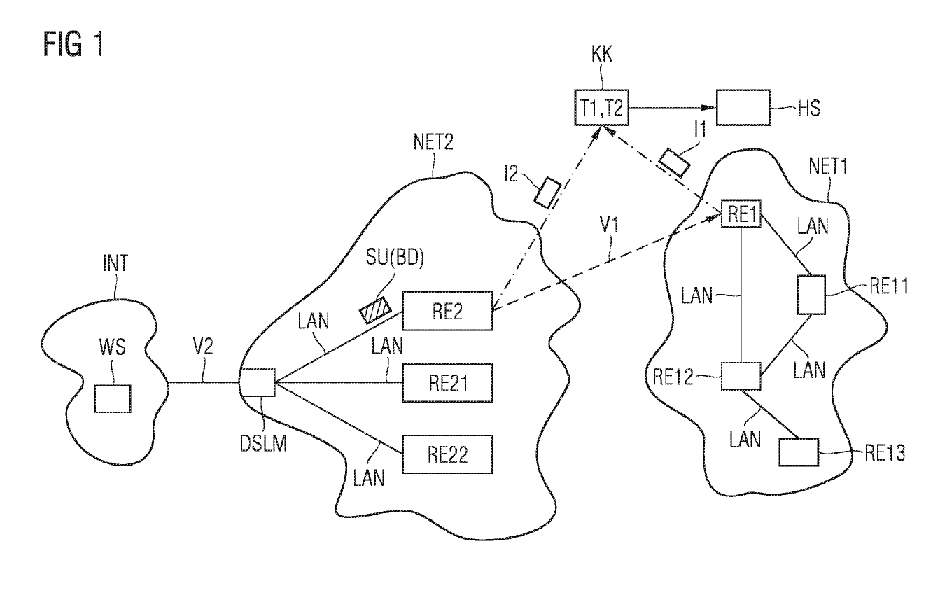

FIG. 1 shows an exemplary representation of an exemplary embodiment of the invention;

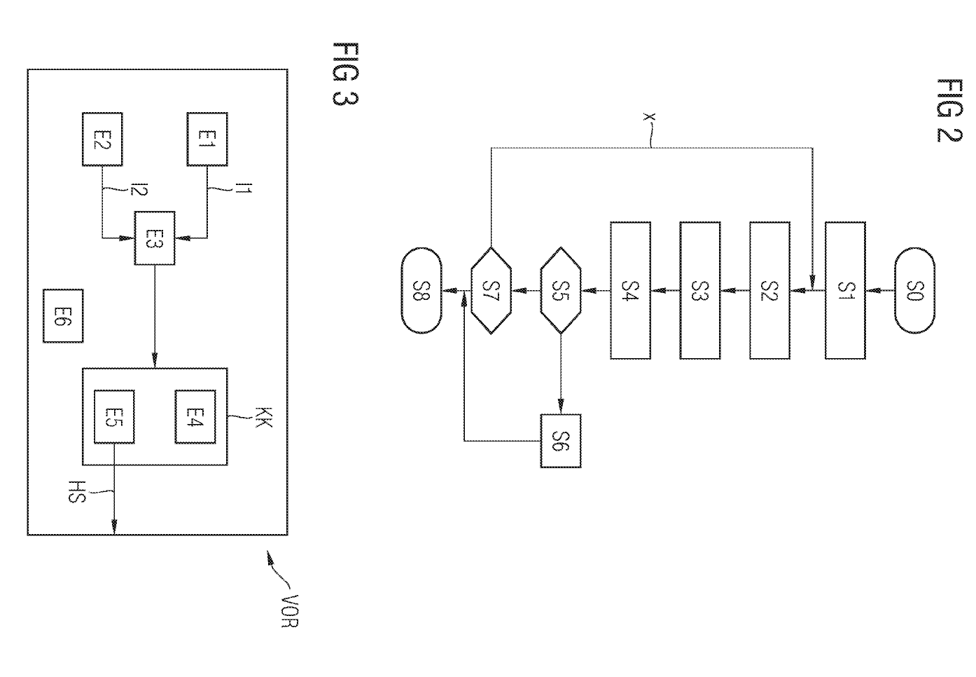

FIG. 2 shows a diagrammatic flowchart for performing a method according to an embodiment of the invention; and

FIG. 3 shows an embodiment of a device which is implemented with the aid of a number of units of the invention.

Elements having the same function and mode of operation are provided with the same reference symbols in the figures.

### DETAILED DESCRIPTION

In the text which follows, an example of embodiments of the invention is described by means of an industrial installation for production robots of a motor car manufacturer according to FIG. 1. At a motor car manufacturer, a production line consisting of a number of welding robots and in each case associated control unit, also called first computer units RE1, RE11, RE12, RE13, is operated. The first computer units are connected to one another via a first network NET1. The first network is implemented by means of LAN (LAN Local Area Network). The first network represents a special network in this context.

The motor car manufacturer also has an office network NET2 in which second computer units RE2, RE21, RE22 are operated by Research, Sales, Service and Marketing. These second computer units can be designed in the form of work PCs and/or mobile terminals. The office network NET2 is also called second network NET2. The second network is connected to the Internet INT via a second link V2 by means of a DSL modem (DSL Digital Subscriber Line). Within the second network NET2, the respective second computer units are networked together by means of LAN in this example.

A service employee downloads a service update SU for one of the control units of the welding robots from a web server WS via his work PC on the Internet INT. During this process, malware BD having a name “XXXX.exe” penetrates, unnoticed by the employee, into the work PC RE2 from the web server WS.

Following this, the service employee would like to load new welding software into the control unit RE1. For this purpose, he loads the new welding software together with the service update SU from his work PC RE2 onto a mobile storage medium V1, e.g. a USB stick. The USB stick is used for transmitting data from the second computer unit of the second network to the first computer unit in the first network. Thus, the mobile storage medium V1 represents a first link V1 between the first network and the second network. In an alternative, the first link can be a wire-connected medium, e.g. a LAN link.

Unnoticed by the service employee, the malware BD present on the service PC also loads itself onto the USB stick, e.g. as part of the service update SU. Following this, the service employee undocks the USB stick from the work PC and inserts it into the USB port of the control unit. During the transmission of the new welding software into the control unit, the malware BD also copies itself into the control unit of the welding robot RE1.

To detect autonomous, self-propagating malware, the work PC RE2 and the welding robot RE1 are monitored. For this purpose, the control unit of the welding robot RE1 determines, e.g. every second, the programs started on its computer unit during the last second, for example all started programs having a file name ending “.exe”, which it stores as first indicator Il in the form of a list. Analogously thereto, the work PC determines every second the programs started on its computer unit during the last second, for example all started programs having a file name ending “.exe” which it deposits as second indicator 12 in the form of a list. The first indicator Il and the second indicator 12 are conveyed to a correlation component KK. The correlation component is a computer which is located, for example, outside the first and second network. Transmission of the first and second indicator takes place via WLAN (WLAN—wireless LAN).

The first indicator I1 comprises, for example, the following file names:
D1519.exe
G011A. exe
XXXX.exe

The second indicator I2 comprises, for example, the following file names:
NN4711.exe
MCHP.exe
DD22DD0a.exe
XXXX.exe
D55.exe

The correlation component compares the respective lists of the first and second indicator and finds a correspondence with respect to the file name XXXX.exe. Thus, the comparison of the lists creates a correlation result KE which indicates the file XXXX.exe.

In this example, a definable threshold value SW which indicates a detection of the autonomous, self-propagating malware is defined in such a manner that the threshold value is exceeded if the correlation result indicates at least one file name.

Since the correlation result indicates the file name XXXX.exe, a definable threshold value SW is exceeded so that an instruction signal HS is output. By this means, the detection of a malware in the first and second network is indicated to a security official. The indication is provided by means of an instruction lamp HS controlled by a fifth unit E5.

To reduce false alarms, the file names or information items, respectively, which, according to prior knowledge about the operating system used on the respective computer unit and/or programs installed without malware, are expected on the respective computer unit, are removed in a development of the exemplary embodiment by the first or second computer unit or by the correlation component from the first and/or second indicator I1, I2. For example, it is assumed that the first and the second computer unit are installed without autonomous, self-propagating malware after the first installation. Subsequently, the lists for the first and second indicator are generated, for example for two days. Next, basic lists comprising at least a part of the information contained in the respective indicator are generated in the respective computer unit and/or correlation component. The creation of the correlation result and the comparison with the threshold value do not take place in this initialization phase. After conclusion of the initialization phase, an exclusion list with information items is available to the respective indicator, these information items being excluded during the generation of the correlation result.

In the above example, the first exclusion list for the first indicator comprises the file names “D1519.exe” and “G011A.exe” and the second exclusion list for the second indicator comprises the file name “N4711.exe”. This results in “XXXX.exe” for the first indicator I1 and “MCHP.exe”, “DD22DD0a.exe”, “XXXX.exe” and “D55.exe” for the second indicator 12. The information items of these indicators is checked analogously to the above exemplary embodiment.

In another exemplary embodiment, the respective indicators indicate which file names have been rewritten or/and altered within a considered period of time, e.g. one minute, on the storage medium allocated to the respective computer unit.

Analogously to the above example, the malware is detected if identical file names are indicated by the indicators.

Certain file names can be excluded as shown above.

In a further exemplary variant of embodiments of the invention, the frequency of an occurrence of certain processes can be monitored in the respective computer units RE1 and RE2 and transmitted as information in the form of the first and second indicator I1, I2 to the correlation component KK.

The first indicator I1 comprises, for example, the following process names and their frequency:
P1212, 125-times
P7781N, 1-time
Pbad12X, 999-times

The second indicator I2 comprises, for example, the following process names and their frequency:
NN4711p, 12-times
MC1212, 22-times
DD22DD0a, 100-times
Pbad12X, 1210-times
D55, 55-times

The correlation component detects that the process “Pbad12X” occurs both in the work PC and in the control unit of the welding robot. In addition, the said process occurs very cumulatively. From this, the correlation component can conclude that the same process “Pbad12X” in each case assumes a very dominant role in the respective process sequence in the two differently designed computer units, work PC and welding robot. The correlation result obtained hereby is that the same process indicates a very similar and noticeable behavior in the work PC and the control unit. Thus, the “Pbad12X” process occurs with a frequency of 999/(999+1+125)=88.8% in the first indicator and with a frequency of 1210/(12+22+100+1210+55)=86.5% in the second indicator. The definable threshold value indicates that the said process occurs in both computer units with a frequency of occurrence of more than 85%. The definable threshold value SW, which indicates a frequency of a particular process in comparison with other processes, is exceeded by the first and second indicator. In this case, the malware is detected in the “Pbad12X” process and an instruction signal is output.

A further exemplary embodiment of the invention can occur via the characteristic of network traffic data observed and relates to all types of direct systematic data acquisition, logging and monitoring of processes. The network traffic monitoring of the respective first and second networks, starting from the respective second computer units in the direction of first computer units, is performed regularly for this purpose in order to be able to detect by means of corrections of the results whether certain threshold values are undercut or exceeded.

In a further exemplary embodiment, the observation of a number of indicators can be carried out. E.g., the occurrence of “XXXX.exe” considered in the exemplary embodiment, in combination with the storage characteristic on the respective computer unit, can be seen as an indicator.

In a further example, an intrusion detection system (network intrusion detection system) is installed in each case in the network NET1 and the office network NET2. The intrusion detection system obtains its information from log files, kernel data and other system data of the first and second computer units and raises the alarm as soon as it detects a possible attack. The intrusion detection systems of the networks NET1 and NET2 send the detected events by means of the respective indicators to the correlation component KK which checks whether an attack took place in the network NET1 and before that in time an identical or similar attack in the office network NET2. If that is a case, an instruction signal HS is output via the instruction signal generator E5.

In the previous examples, only a first and a second computer unit were discussed in each case. Thus, the examples can be extended in such a respect that a number of first and a number of second computer units are present which in each send first and second indicators, respectively, to the correlation component. In this context, a frequency of an occurrence of a file and/or of a process can also be evaluated in such a respect that the respective frequency is determined over all first indicators or all second indicators, respectively. In this context, the infestation of a plurality of first and second computer units is also detected apart from an infestation of a respective first and second computer unit with the malware.

In FIG. 2, a flowchart of an exemplary embodiment of a method for detecting malware is shown.

The method starts with step S0.

In step S1, at least one of the first indicators, which specifies a first behavior of the first computer unit, is detected.

In step S2, at least one of the second indicators, which specifies a second behavior of the second computer unit of the second network, is detected.

In step S3, the first indictor and the second indicator are conveyed to a correlation component.

In step S4, the correlation result is generated by correlating the first indicator with the second indicator.

In step S5, the correlation result is compared with a definable threshold value. If the threshold value is not exceeded, the method is continued with step S7. If the threshold value is exceeded, step S6 follows.

In step S6, an instruction signal is output and thus the presence of the malware is detected.

In step S7, it is checked whether a predetermined time interval has elapsed. If this the case, step S8 takes place. If this is not the case, step S2 takes place. This loop x is followed until the predetermined time interval, e.g. one minute, has elapsed.

The method ends in step S8.

Embodiments of the invention also relate to a device for detecting autonomous, self-propagating malware in at least one first computer unit in a first network, wherein the first network can be coupled to a second network via a first link, comprising the following units, see FIG. 3:
a) first unit E1 for generating at least one first indicator which specifies a first behavior of the at least one first computer unit;
b) second unit E2 for generating at least one second indicator which specifies a second behavior of at least one second computer unit of the second network;
c) third unit E3 for conveying the at least one first indicator and the at least one second indicator to a correlation component;
d) fourth unit E4 for generating at least one correlation result by correlating the at least one first indicator with the at least one second indicator;
e) fifth unit E5 for outputting an instruction signal if, during a comparison, the correlation result exceeds the definable threshold value.

The respective units and the correlation components can be implemented in software, hardware or any combination of software and hardware. Thus, the respective units can be designed for communication with one another via input and output interfaces. These interfaces are coupled directly or indirectly to a processor unit which reads out and processes coded instructions for respective steps to be executed from a storage unit connected to the processor unit.

Although the invention has been illustrated and described in greater detail by the preferred exemplary embodiment, the invention is not restricted by the examples disclosed and other variations can be derived therefrom by the expert without departing from the scope of protection of the invention. In particular, the individual examples can be combined arbitrarily.

1. A method for detecting autonomous, self-propagating malware in at least one first computer unit in a first network, wherein the first network (NET1) is coupled to a second network via a first link, the method comprising:
a) generating at least one first indicator which specifies a first behavior of the at least one first computer unit;
b) generating at least one second indicator which specifies a second behavior of at least one second computer unit in the second network;
c) conveying the at least one first indicator and the at least one second indicator to a correlation component;
d) generating at least one correlation result by correlating the at least one first indicator with the at least one second indicator; and
e) outputting an instruction signal if, during a comparison, a definable threshold value is exceeded by the at least one correlation result.

2. The method as claimed in claim 1, wherein a system for monitoring and/or controlling technical processes of industrial installations is formed by the first network and an office communication network is formed by the second network.

3. The method as claimed in claim 1, wherein the respective behavior with respect to at least one of the following information items of the at least one first computer unit and the at least one second computer unit is determined by the at least one first indicator and the at least one second indicator:
at least one file name on a storage medium;
at least one name of a current or stopped process;
at least one result of an intrusion detection system; and
a characteristic of network traffic data within the first and second network.

4. The method as claimed in claim 3, wherein the at least one first indicator and the at least one second indicator are determined in dependence on a change of the respective information.

5. The method as claimed in claim 1, wherein the at least one first indicator and the at least one second indicator are generated at regular intervals.

6. The method as claimed in claim 1, wherein a first type of behavior of the at least one first computer unit is indicated in a first time interval by the at least one first indicator and the first type of behavior of the at least one second computer unit is indicated in a second time interval by the at least one second indicator, the second time interval being arranged before the first time interval in time.

7. The method as claimed in claim 1, wherein at least one of steps a), c), d), e) is performed only after at least one data word of the at least one second computer unit has been transmitted to the at least one first computer unit.

8. A device for detecting autonomous, self-propagating malware in at least one first computer unit in a first network, wherein the first network is coupled to a second network via a first link and the second network is coupled to a public network via a second link, the device comprising:
a) a first unit for generating at least one first indicator which specifies a first behavior of the at least one first computer unit;
b) a second unit for generating at least one second indicator which specifies a second behavior of at least one second computer unit of the second network;
c) a third unit for conveying the at least one first indicator and the at least one second indicator to a correlation component;
d) a fourth unit for generating at least one correlation result by correlating the at least one first indicator with the at least one second indicator; and
e) a fifth unit for outputting an instruction signal if, during a comparison, the at least one correlation result exceeds the a definable threshold value.

9. The device as claimed in claim 8, wherein the first unit and the second unit, for generating the at least one first indicator and the at least one second indicator, determine the respective behavior with respect to at least one of the following information items:
at least one file name on a storage medium;
at least one name of a current or stopped process;
at least one result of an intrusion detection system; and
a characteristic of network traffic data within the first and second network.

10. The device as claimed in claim 9, wherein the first unit and the second unit perform the generating of the at least one first indicator and the at least one second indicator in dependence on a change of the respective information.

11. The device as claimed in claim 8, wherein the first unit and the second unit perform the generating of the at least one first indicator and the at least one second indicator at regular intervals.

12. The device as claimed in claim 8, wherein a first type of behavior in a first time interval is indicated by the at least one first indicator and the first type of behavior in a second time interval is indicated by the at least one second indicator, the second time interval being arranged before the first time interval in time.

13. The method as claimed in claim 4, wherein the at least one first indicator and the at least one second indicator are determined in dependence on a frequency of occurrence of the respective information.

14. The device as claimed in claim 9, wherein the first unit and the second unit perform the generating of the at least one first indicator and the at least one second indicator in dependence on a frequency of occurrence of the respective information.
